(19) United States
(12) Patent Application Publication
(10) Pub. No.: US 2013/0178547 A1
(43) Pub. Date: Jul. 11, 2013

(54) Process for Recovering Brominated Styrene-Butadiene from a Bromination Reaction Solution

(71) Applicants: John W. Hull, JR., Midland, MI (US); Bruce A. King, JR., Midland, MI (US); Shari L. Kram, Midland, MI (US); Joseph J. Kiefer, Auburn, MI (US)

(72) Inventors: John W. Hull, JR., Midland, MI (US); Bruce A. King, JR., Midland, MI (US); Shari L. Kram, Midland, MI (US); Joseph J. Kiefer, Auburn, MI (US)

(21) Appl. No.: 13/818,859

(22) PCT Filed: Sep. 19, 2011
(86) PCT No.: PCT/US2011/052116

§ 371 Date: Feb. 25, 2013

Related U.S. Application Data
(60) Provisional application No. 61/388,265, filed on Sep. 30, 2010.
(60) Provisional application No. 61/427,194, filed on Dec. 26, 2010.

(51) Int. Cl. C08F 8/20

(52) U.S. Cl. CPC C08F 8/20
USPC 521/81; 525/378; 525/340

(57) ABSTRACT

Brominated styrene-butadiene copolymers are recovered from solutions in a halogenated solvent by an anti-solvent precipitation process. The precipitation process is performed by adding the anti-solvent to the brominated styrene-butadiene copolymer solution. By performing the precipitation using this specific order of addition, a denser product is obtained that is easier to dry. The recovered product shows a reduced tendency to act as a nucleating agent when it is used as a flame retardant additive in an extrusion foaming process.

This application claims priority from U.S. Provisional Patent Application No. 61/388265, filed 30 Sep. 2010 and U.S. Provisional Patent Application No. 61/427,194, filed 26 Dec. 2010.

The present invention relates to a process for recovering a brominated styrene-butadiene copolymer from solution in a halogenated solvent.

Brominated styrene-butadiene copolymers are candidates for use as flame retardants for polymers such as polystyrene foam. WO 2008/021417 and WO 2008/021418 describe processes for performing the bromination. WO 2008/021418 describes a process in which elemental bromine is used as the brominating agent. WO 2008/021418 also describes precipitation methods for recovering the brominated copolymer from the bromination reaction solution. In an example, a hazy solution of the brominated copolymer in cyclohexane is precipitated by adding 2-propanol (an anti-solvent) to the reaction solution.

WO 2008/021417 describes an alternative process, in which bromination is performed in solution using a phenyltrialkylammonium tribromide, benzyltrialkylammonium tribromide or tetraalkylammonium tribromide brominating agent. A highly selective bromination of aliphatic carbon-carbon double bonds is achieved, leaving any aromatic rings that may be present (such as in polystyrene-polybutadiene block co-polymers) essentially unaffected. This process also largely avoids brominating at tertiary carbon atoms and onto allylic carbon atoms, which is important for obtaining the thermal stability that is needed when the brominated copolymers are melt-processed. WO 2008/021417 describes recovering the brominated copolymer from the bromination reaction solution by adding the reaction solution to an anti-solvent such as 2-propanol.

The precipitation process described in WO 2008/021417 tends to form a very low bulk density precipitate. The product tends to precipitate at least partially in the form of large agglomerates that trap significant amounts of the solvent or anti-solvent. This makes it difficult to dry the product. The low bulk density is a problem, too, because packaging costs and storage/shipping costs are higher per unit weight. The product density can be increased by performing a compaction step prior to packaging the product for shipment or storage. This has the disadvantages of requiring an additional manufacturing step and requiring additional processing equipment, both of which increase manufacturing costs.

Brominated styrene-butadiene polymers made in accordance with WO 2008/021417 sometimes have an adverse effect when used as an additive in a foam extrusion process. The cell size of the foam tends to be smaller when the brominated styrene-butadiene polymer is present when the foam is extruded. This suggests that the brominated polymer or some impurity within it is acting as a cell nucleator that increases the number of cells that form. The smaller cells are less efficient at expanding the polymer mass as it exits the extruder die. As a result, the foam sometimes does not expand completely and the foam density tends to be somewhat higher than desired. Higher foam densities increase production costs because more of the resin material is needed to produce a given volume of foam.

It would be desirable to provide a process for recovering a brominated styrene-butadiene copolymer from a bromination reaction solution in the form of fine, dense particles that are easily dried. It would also be desirable to provide a brominated styrene-butadiene polymer that has little or no tendency to reduce cell size when used as a flame retardant in an extrusion foaming process.

The present invention is in one aspect a process for recovering a brominated styrene-butadiene copolymer from solution, comprising adding an antisolvent to a solution of the brominated styrene-butadiene copolymer in at least one halogenated solvent and precipitating the brominated styrene-butadiene copolymer from the solution.

The brominated styrene-butadiene copolymer solution may be, for example, a reaction solution obtained from a bromination process in which a starting styrene-butadiene copolymer is brominated. In such a case, the invention is, in some embodiments, a process for forming a brominated styrene-butadiene copolymer comprising a) reacting a styrene-butadiene copolymer containing aliphatic carbon-carbon double bonds with a quaternary ammonium tribromide or quaternary phosphonium tribromide in the presence of at least one halogenated solvent to form a solution of the brominated styrene-butadiene copolymer in the halogenated solvent and b) adding an antisolvent to the solution of the brominated styrene-butadiene copolymer and precipitating the brominated styrene-butadiene copolymer from the solution.

In other embodiments, the process of the invention is part of a reprecipitation process by which a brominated styrene-butadiene copolymer is dissolved into a halogenated solvent and then recovered from that halogenated solvent by adding an antisolvent to the solution and precipitating the brominated styrene-butadiene copolymer from the solution. Such a reprecipitation process is useful, for example, to purify a brominated styrene-butadiene copolymer, to convert a brominated styrene-butadiene copolymer to a denser form, or to improve its performance in extrusion foaming processes.

Applicants have surprisingly found that when a brominated styrene-butadiene copolymer is precipitated from a halogenated solvent through the use of an anti-solvent, the efficacy of the anti-solvent process depends strongly on the order of addition. This is especially the case when the brominated copolymer solution is a reaction solution obtained from a bromination process in which a starting styrene-butadiene copolymer is brominated using a quaternary ammonium tribromide or quaternary phosphonium tribromide brominating agent. When the brominated copolymer solution is added to the antisolvent, the copolymer precipitates in the form of large, loose aggregates. These aggregates have a low bulk density, and in addition trap large amounts of solvent and anti-solvent. The trapped solvent and/or antisolvent becomes difficult to remove from these agglomerates, which means that the costs to do so can become significant. In some cases, it can become difficult to remove the solvent or antisolvent without causing the brominated copolymer to thermally degrade.

Conversely, when the brominated copolymer is precipitated by adding the anti-solvent to the brominated copolymer solution, the polymer precipitates in the form of fine, dense particles. These smaller particles do not trap large amounts of solvent and anti-solvent, and for that reason they are dried more easily, with less chance of thermal degradation. The smaller, higher density particles require fewer packaging, shipping and storage expenses, even if they are not compacted, because of their smaller volumes per unit weight.

Even more surprising is that the order of addition during the brominated copolymer precipitation step affects the performance of the product in extrusion foaming processes. A brominated copolymer obtained by the conventional precipitation process, in which the brominated styrene-butadiene copolymer solution is added to the anti-solvent, often tends to cause a large number of small cells to form. These small cells do not expand the foam efficiently, and as a result the foam densities often are not as low as are wanted, especially when thick (>10 mm, especially >20 mm) foam boardstock is produced. A brominated copolymer precipitated in accordance with this invention tends not to cause this reduction in cell size, and so allows desirably low foam densities to be attained.

The brominated styrene-butadiene copolymer is obtained by adding bromine to a starting styrene-butadiene copolymer. The starting styrene-butadiene copolymer is a copolymer of butadiene and styrene. The copolymer may be a random, block or graft copolymer, and should contain at least 10% by weight of polymerized polybutadiene. The starting copolymer preferably contains at least 40%, at least 50% at least 60% or even at least 65% by weight polymerized butadiene. It preferably contains from 10 to 90%, more preferably from 20 to 50%, still more preferably from 20 to 40% and even more preferably from 25 to 35% by weight polymerized styrene. The most preferred type of starting styrene-butadiene polymer is a block copolymer containing one or more polystyrene blocks and one or more polybutadiene blocks. Among these, diblock copolymers, and triblock copolymers having a central polybutadiene block and terminal polystyrene blocks, are especially preferred.

The starting styrene-butadiene polymer may also contain repeating units formed by polymerizing monomers other than butadiene and a vinyl aromatic monomer. Such other monomers include olefins such as ethylene and propylene, acrylate or acrylic monomers such as methyl methacrylate, methyl acrylate, acrylic acid, and the like. These monomers may be randomly polymerized with the styrene and/or butadiene, may be polymerized to form blocks, or may be grafted onto the styrene-butadiene copolymer.

The starting styrene-butadiene polymer has a weight average molecular weight (M_{w}) within a range of from 25,000 to 400,000, preferably from 50,000 to 300,000, more preferably from 75,000 to 200,000 and even more preferably from 100,000 to 175,000. For purposes of this invention, molecular weights are apparent molecular weights as measured by Gel Permeation Chromatography (GPC), relative to a polystyrene standard. GPC molecular weight determinations can be performed using an Agilent 1100 series liquid chromatograph equipped with two Polymer Laboratories PLgel 5 micrometer Mixed-C columns connected in series and an Agilent G1362A refractive index detector, with tetrahydrofuran (THF) flowing at a rate of 1 mL/min and heated to a temperature of 35° C. as the eluent.

Butadiene polymerizes to form two types of repeating units. One type, referred to herein as “1,2-butadiene units” takes the form

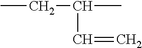

and so introduces pendant unsaturated groups to the polymer. The second type, referred to herein as “1,4-butadiene” units, takes the form —CH₂—CH═CH—CH₂—, and introduces unsaturation into the main polymer chain. The starting styrene-butadiene copolymer should contain at least some 1,2-butadiene units. Of the butadiene units in the styrene-butadiene copolymer, suitably at least 10%, preferably at least 15%, more preferably at least 20% and even more preferably at least 25% are 1,2-butadiene units. 1,2-butadiene units may constitute at least 50%, at least 55%, at least 60% or at least 70% of the butadiene units in the butadiene polymer. The proportion of 1,2-butadiene units may be in excess of 85% or even in excess of 90% of the butadiene units in the starting styrene-butadiene copolymer.

Methods for preparing styrene-butadiene copolymers with controlled 1,2-butadiene content are described by J. F. Henderson and M. Szwarc in Journal of Polymer Science (D, Macromolecular Review), Volume 3, page 317 (1968), Y. Tanaka, Y. Takeuchi, M. Kobayashi and H. Tadokoro in J. Polym. Sci. A-2, 9, 43-57 (1971), J. Zymona, E. Santte and H. Harwood in Macromolecules, 6, 129-133 (1973), and H. Ashitaka, et al., in J. Polym. Sci., Polym. Chem., 21, 1853-1860 (1983).

Styrene-butadiene block copolymers are widely available in commercial quantities. Those available from Dexco Polymers under the trade designation VECTOR™ are suitable. Styrene/butadiene random copolymers may be prepared in accordance with the processes described by A. F. Halasa in Polymer, Volume 46, page 4166 (2005). Styrene/butadiene graft copolymers may be prepared in accordance with methods described by A. F. Halasa in Journal of Polymer Science (Polymer Chemistry Edition), Volume 14, page 497 (1976). Styrene/butadiene random and graft copolymers may also be prepared in accordance with methods described by Hsieh and Quirk in chapter 9 of Anionic Polymerization Principles and Practical Applications, Marcel Dekker, Inc., New York, 1996.

The brominated styrene-copolymer is brominated across at least some of the aliphatic carbon-carbon double bonds of the butadiene units of the starting copolymer. Typically, at least 25% of the butadiene units in the starting styrene-butadiene copolymer are brominated. More preferably, at least 50% and more preferably at least 70% and even more preferably at least 80% or even at least 90% of the butadiene units are brominated. The bromine content of the brominated styrene-butadiene copolymer may be from 5 to 75% by weight. It is preferably at least 40% by weight, more preferably at least 50% by weight and still more preferably at least 60% by weight.

The brominated styrene-butadiene copolymer preferably has little or no bromination at allylic or tertiary carbon atoms, or on aromatic rings.

The extent of bromination can be determined using proton NMR methods. Residual double bond percentage, polymerized styrene monomer content and 1,2 isomer content can be determined by comparing integrated areas of signals due to appropriate protons (residual double bond protons are between 4.8 and 6 ppm) (relative to tetramethylsilane (TMS)), styrene aromatic protons are between 6.2-7.6 ppm, and protons for brominated polybutadiene are between 3.0 and 4.8 ppm). A Varian INOVA™ 300 NMR spectrometer or equivalent device is useful for such determinations, being operated with a delay time of 30 seconds to maximize relaxation of protons for quantitative integrations. A deutero-substituted solvent such as deutero-chloroform or d5-pyridine is suitable for diluting the sample for NMR analysis.

A preferred way of making the brominated styrene-butadiene copolymer is by brominating the starting styrene-butadiene copolymer in solution in at least one halogenated solvent, using a quaternary ammonium tribromide or quaternary phosphonium tribromide brominating agent. Preferred halogenated solvents include polyhalogenated alkanes and mono-or polyhalogenated aromatic compounds. A useful polyhalogenated alkane preferably contains from 1 to 8 carbon atoms, more preferably 1 or 2 carbon atoms, and at least two halogen atoms. The halogen atoms are preferably chlorine and more preferably bromine, although a polyhalogenated solvent may contain two or more different types of halogen atoms, such as one or more chlorines and one or more bromines. The halogen atoms all may be bonded to a single carbon atom, or may be bonded to two or more of the carbon atoms. Preferred polyhalogenated alkanes include dichloromethane, dibromomethane, bromochloromethane, chloroform, carbon tetrachloride, 1,2-dichloroethane, 1,1-dichloroethane, 1,2-dibromoethane, 1,1-dibromoethane, and the like.

Halogenated aromatic compounds that are useful solvents may have one or more halogen atoms, which are preferably chlorine and more preferably bromine, and may contain a single or multiple rings. Multiple rings may have fused and/or bridged structures. Examples of useful halogenated aromatic compounds include chlorobenzene, polychlorinated benzenes, bromobenzene, or polybrominated benzenes.

In some embodiments, the solvent is a mixture that contains (1) at least one polyhalogenated alkane and/or at least one halogenated aromatic compound and (2) at least one monohalogenated alkane. Such a monohalogenated alkane preferably contains from 1 to 8 carbon atoms, more preferably 1 or 2 carbon atoms, and only one atom. The halogen atom is preferably chlorine and more preferably bromine. Examples of monohalogenated alkane solvents include methyl bromide, methyl chloride, ethyl bromide, ethyl chloride, propyl bromide (any isomer or mixture of isomers), propyl chloride (any isomer or mixture or isomers), and the like. The ratio of the polyhalogenated alkane or halogenated aromatic compound and the monohalogenated alkane may be from about 3:1 to about 1:3 by weight.

The preferred brominating agent is a quaternary ammonium tribromide or a quaternary phosphonium tribromide. Pyridinium tribromide, phenyltrialkylammonium tribromides, benzyltrialkylammonium tribromides and tetraalkylammonium tribromides are suitable quaternary ammonium tribromides. Specific examples include phenyltrimethylammonium tribromide, benzyltrimethylammonium tribromide, tetramethylammonium tribromide, tetraethylammonium tribromide, tetrapropylammonium tribromide, tetra-n-butylammonium tribromide and the like. Suitable quaternary phosphonium tribromides contain a quaternary phosphonium group that can be represented by the formula R₄P⁺, where each R is a hydrocarbon group. The quaternary phosphonium tribromide may be a tetraalkylphosphonium tribromide, in which case each of the R groups is alkyl. The four R groups can all be the same. Alternatively, there may two, three or even four different R groups attached to the phosphorus atom. The R groups each are preferably alkyl having from one to 20 carbon atoms. The R groups more preferably are alkyl groups having from 1 to 8 carbon atoms. Examples of specific quaternary phosphonium tribromides include tetramethylphosphonium tribromide, tetraethylphosphonium tribromide, tetra(n-propyl)phosphonium tribromide, tetra(n-butyl)phosphonium tribromide, tetrahexylphosphonium tribromide, tetraoctylphosphonium tribromide, trihexyltetradecylphosphonium tribromide, and the like, or mixtures thereof.

The quaternary ammonium tribromide or quaternary phosphonium tribromide brominating agent can be prepared by mixing the corresponding quaternary ammonium or quaternary phosphonium monobromide salt with elemental bromine. The monobromide salt is usually water-soluble and is often available commercially as an aqueous solution, so a convenient way of making the tribromide is to add elemental bromine to an aqueous solution of the monobromide salt. This reaction proceeds well at approximately room temperature, but higher or lower temperatures can be used if desired. The tribromide tends to precipitate from the aqueous phase, and so may be recovered from the liquid phase by any convenient solid-liquid separation method. The tribromide is soluble in organic solvents such those described above, and may be dissolved in such a solvent if desired to facilitate blending with the starting butadiene polymer. In an alternative approach, the neat monobromide salt can be treated with elemental bromine in an organic solvent, without the presence of water.

In addition, the tribromide may be formed in situ in the presence of the solvent mixture and/or the starting styrene-butadiene copolymer, as described more fully below. This process has the advantage of using less of the expensive compound that serves to carry the bromine added to the polymer and is preferred.

The reaction is conducted by mixing the starting styrene-butadiene copolymer, solvent and quaternary ammonium tribromide or quaternary phosphonium tribromide together and allowing the mixture to react until the desired proportion of the butadiene units has been brominated. The order of addition is not especially important, except that if the tribromide and starting styrene-butadiene copolymer are mixed first, it is preferred to add the solvent before significant reaction occurs.

Enough of the solvent is used to dissolve the starting styrene-butadiene copolymer as well as the brominated copolymer that is generated during the course of the reaction. The concentration of the starting styrene-butadiene copolymer in the solvent may range from, for example, 1 to 50% by weight, especially from 5 to 35% by weight. About 0.5 to about 5 moles of the tribromide brominating agent are suitably used per mole of butadiene units in the starting polymer; a more suitable amount is from about 0.9 to about 2.5 moles/mole and an even more suitable amount is from 1 to 1.5 moles/mole.

Generally, only mild conditions are needed to effect the bromination. Bromination temperatures can range from −20 to 100° C., and are preferably from 0 to 85° C. and especially from 10 to 40° C. Temperatures higher than 100° C. could be used, but are not necessary and may lead to a loss of selectivity and/or an increase in by-products. The tribromide becomes converted to the corresponding quaternary ammonium or quaternary phosphonium monobromide salt as the reaction proceeds.

The time of the reaction is sufficient to achieve the desired amount of bromination. This may range from a few minutes to a few hours, depending on conditions and the extent to which the starting copolymer is to be brominated. It has been found that the bromination tends to proceed rapidly until about 60-80% of the butadiene units have become brominated. At higher conversions, bromination rates often become slower. Faster bromination rates at higher conversions can be obtained by adding some water to the reaction solution after about 20-80% of the butadiene units have become brominated. The addition of water after the bromination has already proceeded to some extent has been found to significantly increase bromination rates at higher conversions, and permit highly brominated products to be obtained at commercially reasonable reaction times.

In certain embodiments of the invention, the tribromide brominating agent is formed in situ in the reaction mixture by separately adding elemental bromine and the corresponding quaternary ammonium monobromide salt or quaternary phosphonium monobromide salt. It is believed that the bromine and monobromide salt form the tribromide upon being mixed together, with the resulting tribromide then reacting with the starting styrene-butadiene copolymer to brominate the copolymer and regenerate the monobromide salt. As elemental bromine is consumed in this reaction sequence, more bromine may be added to the reaction mixture continuously or intermittently to reproduce the tribromide and maintain the reaction.

The ability to form the tribromide brominating agent in situ lends itself to the operation of a continuous or semi-continuous process, in which elemental bromine is fed into a reaction mixture continuously or in any number of stages, as the tribromide is consumed in the reaction and the monobromide salt is regenerated. The elemental bromine combines with the regenerated monobromide salt to re-form the tribromide.

In other embodiments of the invention, the starting solution is not a reaction solution from a bromination reaction, but instead is a separately-formed solution made by dissolving a brominated styrene-butadiene copolymer in a halogenated solvent. The halogenated solvent may be any of the types described before, with respect to solvents for the bromination reaction. The brominated styrene-butadiene copolymer in this case may have been recovered from a brominated reaction solution by some other means (including a conventional anti-solvent process). The process of this invention may be part of a process for purifying the brominated copolymer or forming a denser product.

According to the invention, the brominated styrene-butadiene copolymer is recovered from solution in a halogenated solvent by adding an anti-solvent to the solution, in an amount sufficient to cause the brominated copolymer to become insoluble and precipitate. By adding the anti-solvent “to” the brominated copolymer solution, it is meant that the anti-solvent is mixed with the brominated copolymer solution in a manner such that, during the course of the addition, the concentration of anti-solvent in the mixture becomes increased and the concentration of the halogenated solvent (and brominated styrene-butadiene copolymer) in the mixture becomes decreased. In a conventional process in which the reaction solution is added to the anti-solvent, the concentration of the anti-solvent decreases and the concentration of the halogenated solvent increases in the mixture during the course of the addition step.

The addition step preferably is performed over a period of at least one minute to about two hours, preferably over a period of from 5 minutes to one hour and still more preferably from about 15 minutes to about one hour. The amount of anti-solvent is typically from about 1 to about 10 volumes per volume of the brominated copolymer solution, more typically from 2 to 5 volumes per volume of the brominated copolymer solution.

The temperature at which the addition step is performed may be any temperature between the freezing and boiling temperatures of the reaction solvent and the anti-solvent.

The addition step is preferably performed while agitating or otherwise mixing the brominated styrene-butadiene copolymer solution.

Examples of such anti-solvents include lower alcohols such as methanol, ethanol and 1-propanol, 2-propanol, n-butanol, and t-butanol. In addition to these, effective anti-solvents may also include other polar aprotic solvents in which the brominated polymer has low solubility, such as acetone and acetonitrile. Mixtures of two or more anti-solvents can be used. It is also possible to perform the precipitation by adding two or more different anti-solvents sequentially to the brominated styrene-butadiene copolymer solution.

The brominated styrene-butadiene copolymer precipitates as the anti-solvent is added. After the addition step is complete, the resulting mixture may be stirred for a period to allow the brominated styrene-butadiene copolymer to continue to precipitate.

The precipitated copolymer is then recovered from the mixture by any convenient solid-liquid separation process, such as simple filtration, vacuum filtration, centrifugation and the like.

The precipitated copolymer typically has a bulk density of at least 0.25 g/mL and preferably at least 0.35 g/mL or at least 0.40 g/mL. The bulk density is often as high as 0.75 g/mL, but is more typically up to 0.65 g/mL.

The recovered copolymer may be further purified if desired. In the case where the starting solution is a bromination reaction solution, a purification step may be performed, for example, to remove residual bromine, any residual brominating agent, solvent and any other by-products of the bromination process, as may be desired or needed to render the recovered brominated copolymer suitable a particular application. Bromide salts may be removed by passing the recovered copolymer through silica gel or an ion exchange resin bed.

The brominated styrene-butadiene copolymer obtained from the process of the invention is useful as a flame retardant additive for a variety of organic polymers. Organic polymers of interest include vinyl aromatic or vinyl aromatic polymers (including vinyl aromatic homopolymers, vinyl aromatic copolymers, or blends of one or more vinyl aromatic homopolymers and/or vinyl aromatic copolymers), as well as other organic polymers in which the brominated copolymer is soluble or can be dispersed to form domains of less than 10 μm, preferably less than 5 μm, in size. Enough of the brominated copolymer is preferably present in the blend to provide the blend with a bromine content within a range of from 0.1 percent by weight to 25 percent by weight, based upon blend weight.

The organic polymer containing the brominated copolymer may be cellular. Extruded foams are of particular interest herein, as an advantage of the brominated styrene-butadiene copolymer is that it is highly stable to the conditions of extrusion. A extruded foam is conveniently prepared in a process that comprises forming a pressurized melt that contains a molten bulk polymer, preferably a styrenic polymer, a flame retarding amount of a brominated styrene-butadiene copolymer and at least one blowing agent, and forcing the melt through an opening into a zone of lower pressure, where the blowing agent expands and the bulk polymer cools and solidifies to form a foam.

The blowing agent may be, for example, carbon dioxide, a hydrocarbon having up to about 6 carbon atoms, ethanol, water, a hydrofluorocarbon, a hydrochlorofluorocarbon, a dialkyl ether, or other low-boiling compound. Mixtures of blowing agents can be used, such as a mixture of carbon dioxide and ethanol, a mixture of carbon dioxide and a hydrocarbon, a mixture of carbon dioxide, ethanol and a hydrocarbon, or a mixture of carbon dioxide, ethanol, water and optionally a hydrocarbon.

The extrusion foaming can be performed in conventional foam extrusion equipment. Thus, screw extruders, twin screw extruders and accumulating extrusion apparatus can all be used. Suitable processes for making extruded foams from resin/blowing agent mixtures are described in U.S. Pat. Nos. 2,409,910; 2,515,250; 2,669,751; 2,848,428; 2,928,130; 3,121,130; 3,121,911; 3,770,688; 3,815,674; 3,960,792; 3,966,381; 4,085,073; 4,146,563; 4,229,396; 4,302,910; 4,421,866; 4,438,224; 4,454,086 and 4,486,550. All of those processes are generally applicable for making foam according to this invention.

In the extrusion foaming process, a blend of the bulk polymer and the brominated styrene-butadiene copolymer is heated to a temperature at or above the glass transition temperature of the styrenic polymer to form a melt. Suitable temperatures are at least 180° C., more typically at least 220° C., but preferably no greater than 280° C., more preferably no greater than 260° C. The blowing agent mixture is introduced and mixed into the melt. Optional additives as described below are also blended into the melt. Pressures during the mixing step are maintained high enough so that foam expansion does not begin until the molten mixture passes out of the apparatus into a zone of reduced pressure.

After all components are blended, the molten mixture is usually adjusted to an extrusion temperature before being passed out of the apparatus (typically through an extrusion die) into the zone of reduced pressure. This temperature is typically in the range of from 105 to 135° C. As before, pressures during this step are suitably maintained so that the blowing agents do not expand. After the temperature of the molten mixture is adjusted to the extrusion temperature, the mixture is passed through an extrusion die to an area of reduced pressure (usually atmospheric pressure). The loss of pressure causes the blowing agent to expand rapidly. The expansion of the blowing agent rapidly cools the molten bulk polymer so it hardens as the mass expands, forming a stable foam.

The foam can be extruded into any variety of shapes. The invention provides particular benefits when making boardstock having a thickness of 10 mm or more, especially 20 mm or more, because the somewhat large cell size that is obtained allows the foam to expand easily to a low density.

The melt may be extruded through a die including a multiplicity of orifices arranged such that contact between adjacent streams of the molten extrudate occurs during the foaming process. This causes the contacting surfaces to adhere to one another well enough to result in a unitary structure. Methods for forming such coalesced strand foams are described in U.S. Pat. Nos. 6,213,540 and 4,824,720, both incorporated herein by reference. These coalesced strand foams tend to be highly anisotropic, with the highest compressive strengths generally being observed in the extrusion direction. The coalesced strand foam may include missing strands or designed voids, as described in U.S. Pat. No. 4,801,484, incorporated by reference herein.

The following examples are provided to illustrate the invention, but not to limit the scope thereof. All parts and percentages are by weight unless otherwise indicated.

### EXAMPLE 1 AND COMPARATIVE RUN A

A styrene-butadiene triblock polymer having a weight average molecular weight of 86,000 and containing 55% by weight polymerized butadiene (80% 1,2-units) is brominated in dichloromethane solvent using tetraethylammonium tribromide as the brominating agent. A reaction solution containing 15% by weight of the brominated copolymer is obtained.

In Example 1, 2-propanol is added to a portion of the reaction solution at room temperature. Three volumes of the 2-propanol are added to one volume of stirred reaction solution over a period of 45 minutes. A slurry of fine white copolymer particles forms. The particles are filtered on a coarse glass frit with vacuum to collect the copolymer particles. The copolymer particles are dried under vacuum at 55° C. for 47 hours to produce a white solid having a bulk density of 0.40 g/mL.

In Comparative Run A, one volume of the stirred reaction solution is pumped over a period of one hour into three volumes of 2-propanol with stirring at room temperature. The mixture is stirred for 10 additional minutes after the 2-propanol addition is complete. The resulting slurry is filtered on a coarse glass frit under vacuum and dried under vacuum for 24 hours at 55° C. The dried copolymer has a bulk density of only 0.23 g/mL, or less than 60% that of the Example 1 material.

Foams are prepared using brominated copolymer obtained from Example 1 and from Comparative Run A. In each case, the recovered brominated copolymer is compounded into a polystyrene based masterbatch with additives used to stabilize the brominated copolymer during thermal processing. This concentrate is then let down into more polystyrene (PS-640, from Styron LLC) on a single screw extruder and processed through a 1 inch (2.54 cm) die with ½ inch (1.27 cm) forming plates to form a foam. The concentrate and the polystyrene are fed into the extruder at rates which provide a mixture that contains 1.8% bromine by weight. The blowing agents (a mixture of carbon dioxide, isobutane and water) are then added to the polymer mixture in a rotary mixer at a mixing temperature of 200° C. under enough pressure to prevent the blowing agent mixture from expanding. The resulting foamable composition is then cooled with heat exchangers and discharged through a slot die to form a foam. After the foam is cooled, cell size is measured.

Foam prepared using the brominated copolymer recovered according to Example 1 has a cell size approximately 50% larger than the foam made using the copolymer recovered from Comparative Run A.

### EXAMPLE 2 AND COMPARATIVE RUN B

Example 1 is repeated, this time using a starting styrene-butadiene polymer that has a weight average molecular weight of 140,000 and 68% polymerized butadiene (82% 1,2-units). The bulk density of the recovered product (Example 2) is 0.58 g/mL.

When Comparative Run A is repeated using the 140,000 M_{w}, 68% polymerized butadiene copolymer, the bulk density is only 0.19 g/mL, or only one-third that of Example 2.

### EXAMPLE 3 AND COMPARATIVE RUN C

Example 1 is again repeated, this time using a starting styrene-butadiene polymer that has a weight average molecular weight of 145,000 and 68% polymerized butadiene (75% 1,2-units). The bulk density of the recovered product (Example 2) is 0.46 g/mL.

When Comparative Run A is repeated using the 145,000 M_{w}, 68% polymerized butadiene copolymer, the bulk density is only 0.28 g/mL.

### EXAMPLE 4 AND COMPARATIVE RUNS D AND E

Comparative Run D: A styrene-butadiene copolymer (120,000 M_{w}, 60% butadiene (79% 1,2-butadiene units) is brominated in a halogenated solvent and recovered by a conventional anti-solvent process in which the reaction solution is added to an antisolvent. The precipitated copolymer is dried. Foam is made from a portion of this copolymer, in the general manner described in Example 1. The resulting foam has an average cell size of 0.2-0.32 mm and a foam density of 35.6-36.0 kg/m³.

Comparative Run E: Another portion of the precipitated copolymer is re-dissolved in dichloromethane, and precipitated by adding the resulting solution into 2-propanol. The brominated copolymer is dried and foam is made as before. In this case, cell size is only 47% as large as those obtained in Comparative Run D. Foam density is increased significantly, to 39.8 kg/m³.

Example 4: Another portion of the precipitated copolymer is re-dissolved in dichloromethane, and precipitated by adding 2-propanol to the resulting solution. The brominated copolymer is dried and foam is made as before. In this case, cell size is 90% large as those obtained in Comparative Run D, and nearly double the size of the cells obtained in Comparative Run E. Foam density is 36.6 kg/m³, which is only slightly higher than that of Comparative Run D.

1. A process for recovering a brominated styrene-butadiene copolymer from solution, comprising adding an antisolvent to a solution of the brominated styrene-butadiene copolymer in at least one halogenated solvent and precipitating the brominated styrene-butadiene copolymer from the solution.

2. The process of claim 1 wherein the brominated styrene-butadiene copolymer solution is obtained by reacting a styrene-butadiene polymer containing aliphatic carbon-carbon double bonds with a quaternary ammonium tribromide or quaternary phosphonium tribromide, in the presence of at least one halogenated solvent to form a solution of the brominated styrene-butadiene polymer in the halogenated solvent.

3. The process of claim 1 wherein the brominated styrene-butadiene copolymer solution is prepared by dissolving a brominated styrene-butadiene polymer into a halogenated solvent.

4. The process of claim 1 wherein the halogenated solvent is a polyhalogenated alkane, a mono- or polyhalogenated aromatic compound, or a mixture of any two or more thereof.

5. The process of claim 4 wherein the halogenated solvent is a polyhalogenated alkane containing 1 or 2 carbon atoms and at least two halogen atoms.

6. The process of claim 5 wherein the polyhalogenated alkane is dichloromethane, dibromomethane, bromochloromethane, chloroform, carbon tetrachloride, 1,2-dichloroethane, 1,1-dichloroethane, 1,2- dibromoethane or 1,1- dibromoethane.

7. The process of claim 4 wherein the halogenated solvent is chlorobenzene, polychlorinated benzenes, bromobenzene, or a polybrominated benzene.

8. The process of claim 1 wherein the anti-solvent is methanol, ethanol and 1-propanol, 2-propanol, n-butanol, t-butanol, acetone, acetonitrile or a mixture of any two or more thereof.

9. The process of claim 1 wherein the brominated styrene-butadiene copolymer is prepared by brominating a starting styrene-butadiene copolymer containing at least 40% by weight polymerized butadiene and wherein at least 50% of the butadiene units of the starting styrene-butadiene copolymer are brominated.

10. The process of claim 9, wherein the brominated styrene-butadiene copolymer is a brominated styrene-butadiene block copolymer.

11. The process of claim 1 wherein the precipitated brominated styrene-butadiene copolymer has a bulk density of at least 0.35 g/mL.

12. The process of claim 11 wherein the precipitated brominated styrene-butadiene copolymer has a bulk density from 0.35 to 0.65 g/mL.

13. A process comprising foaming a bulk polymer in an extrusion foaming process in the presence of a brominated styrene-butadiene copolymer obtained from the process of claim 1.
